(19) United States
(12) Patent Application Publication
(10) Pub. No.: US 2024/0321502 A1
(43) Pub. Date: Sep. 26, 2024

(54) MAGNETIC COMPONENT ASSEMBLY

(71) Applicant: Delta Electronics (Shanghai) Co., Ltd., Shanghai (CN)

(72) Inventors: Ruikang Li, Shanghai (CN); Xiaolei Wang, Shanghai (CN); Suhua Chen, Shanghai (CN); Jian Ye, Shanghai (CN)

(21) Appl. No.: 18/382,369

(22) Filed: Oct. 20, 2023

(30) Foreign Application Priority Data
Mar. 23, 2023 (CN) 202320601239.9

(51) Int. Cl. H01F 27/22; H01F 27/02

(52) U.S. Cl. CPC H01F 27/22; H01F 27/022

(57) ABSTRACT

A magnetic component assembly is disclosed and includes a magnetic component, a plastic frame and an insulation tape. The magnetic component includes at least one adjacent side. The plastic frame includes an accommodation space, at least one window and at least one through opening. The magnetic component is accommodated in the accommodation space, the at least one window is spatially corresponding to the at least one adjacent side of the magnetic component, and the at least one through opening is in communication with the accommodation space. The insulation tape is attached to the plastic frame, covers the at least one window, and shields the at least one adjacent side of the magnetic component.

### CROSS-REFERENCE TO RELATED APPLICATION

This application claims priority to China Patent Application No. 202320601239.9, filed on Mar. 23, 2023. The entire contents of the above-mentioned patent application are incorporated herein by reference for all purposes.

### FIELD OF THE INVENTION

The present disclosure relates to a technology field of power electronic devices, and more particularly to a magnetic component assembly capable of meeting the requirements of low thermal resistance and high insulation level at the same time.

### BACKGROUND OF THE INVENTION

With the rapid development of switching power supply technology in various application fields, more and more power supply products are developed in the direction of higher efficiency, higher power density, higher reliability and lower cost. In order to increase the power density of power supply products, the volume and the weight of each part of the whole machine are strictly controlled, and a light and efficient heat dissipation structure is an important condition for achieving high power density and light weight.

Usually, in a larger power supply, and especially the magnetic component of the main power part in the on-board charger (OBC) system, since the heat generated therefrom is larger, and especially the core loss has a large proportion, it causes a significant heat generation. Furthermore, the magnetic component also has high safety insulation requirements relative to the external environment. For potting applications, when the copper bar is served as the winding to form the magnetic component, it is necessary to reduce the thermal resistance under the condition of ensuring the insulation level, and the respective temperature rises of the copper bars and the magnetic core have to be controlled within the safe threshold. However, the requirements of low thermal resistance and high insulation level are often difficult to balance. In order to meet the high insulation level, it is often necessary to thicken/strengthen the insulation material, and increase the creepage distance or electrical clearance, but these processing methods will cause the thermal resistance to increase. Conversely, the low thermal resistance is often difficult to meet insulation requirements.

Generally, an enlarged metal housing is disposed outside the magnetic component to increase the distance between the heat dissipation metal housing and the magnetic component, so as to meet the creepage requirement distance (insulation requirement). Moreover, the magnetic component is further immersed in the heat dissipation adhesive. However, the enlarged the metal housing has to occupy more space, more heat dissipation adhesive needs to be filled, and the cost is higher. Moreover, the thermal resistance is still high due to the longer thermal conduction path. In addition, the insulation tape wrapped on the outside of the magnetic component can also be used as an insulation layer. This insulation treatment method will obviously hinder the direct contact between the magnetic component and the heat dissipation adhesive, and the thermal resistance is relatively higher. Furthermore, it takes a long time to fully cover the magnetic components with insulation tape, and the quality is more difficult to guarantee. Therefore, the conventional magnetic component assembly is difficult to meet the heat dissipation and insulation requirements under increasingly high-power density.

Therefore, there is a need of providing a magnetic component assembly capable of meeting the requirements of low thermal resistance and high insulation level at the same time, so as to obviate the drawbacks encountered by the prior arts.

### SUMMARY OF THE INVENTION

An object of the present disclosure is to provide a magnetic component assembly. For solving the insulation and heat dissipation problems of the magnetic component, especially an inductor or a transformer, a plastic frame with a window and an insulation tape are combined to form an assembly structure that not only meets the safety insulation requirements, but also can dissipate heat efficiently. Moreover, corresponding to the position of an adjacent side of the magnetic component, a directional thermal transfer channel is formed to enhance the thermal transfer capacity in this direction sufficiently, and meet the insulation requirements of the magnetic component in the application environment. With the combination of the magnetic components, the window and the insulation tape, an optimized thermal transfer channel is formed to enhance the heat dissipation efficiency of the magnetic component, simplify the assembling and manufacturing process and reduce the cost at the same time.

Another object of the present disclosure is to provide a magnetic component assembly. The window and the through opening disposed on the plastic frame are utilized to attach an insulation tape and introduce the potting compound, respectively, so as to solve the insulation problem and the heat dissipation problem of the magnetic component at the same time. Since the magnetic component assembly is applied in a metal housing and potted with the heat dissipation adhesive, the requirements for low thermal resistance and high insulation level on the adjacent side of the magnetic component are particularly stringent. When the magnetic component is accommodated in the plastic frame, an insulation protection is provided. Moreover, the windows and the insulation tape are arranged corresponding to the adjacent side of the magnetic component, so as to form a thermal contact, it allows to further optimize the thermal transfer channel and meet the insulation requirements of the magnetic component at the same time. In this way, the part of the magnetic component close to the metal housing and less than the safety creepage distance, also meets the insulation requirements. In addition, the insulation tape is attached to the plastic frame to cover the window, and the magnetic component is directly placed in the plastic frame to realize the thermal contact between the adjacent side of the magnetic component and the corresponding window with the insulation type. The structure is compact and easy to assemble. It avoids the conventional technology, which winds the insulation tape on the whole of the magnetic component through the complicated procedures. Furthermore, the through openings of the plastic frame are misaligned with the adjacent side of the magnetic component, so that the heat dissipation adhesive is introduced into the accommodation space through the through openings and in contact with the magnetic component, and the thermal conductivity is improved. The portion of plastic frame without the windows and the through openings is utilized to separate the magnetic component from the metal housing, increase the creepage distance and meet the safety requirements. Furthermore, the arrangement of the portion of plastic frame without the windows and the through openings is helpful for heat dissipation. The insulation tape is pre-disposed on the plastic frame, and the heat dissipation adhesive is potted after the magnetic component is placed. It allows the magnetic component to form a thermal coupling with the metal housing through the plastic frame, the insulation tape and the potted heat dissipation adhesive. It has advantages of simplifying the assembling process, enhancing the thermal transfer efficiency and meeting the insulation requirements of the magnetic components in the application of the metal housing. In addition, the window is opened on the plastic frame and corresponding to the shortest thermal transfer path between the adjacent side of the magnetic component and the metal housing, so that the thermal resistance is reduced sufficiently, and the heat dissipation performance is enhanced. On the other hand, the insulation tape is attached to the plastic frame and corresponding to the window, so that the insulation protection is achieved, and the creepage distance from the adjacent side of the magnetic component to the metal housing is increased at the same time. The insulation performance of the magnetic component relative to the metal housing is ensured and not affected by the opening position of the windows of the plastic frame.

In accordance with an aspect of the present disclosure, a magnetic component assembly is provided. The magnetic component assembly includes a magnetic component, a plastic frame and an insulation tape. The magnetic component includes at least one adjacent side. The plastic frame includes an accommodation space, at least one window and at least one through opening. The magnetic component is accommodated in the accommodation space, the at least one window is spatially corresponding to the at least one adjacent side of the magnetic component, and the at least one through opening is in communication with the accommodation space. The insulation tape is attached to the plastic frame, covers the at least one window, and shields the at least one adjacent side of the magnetic component.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a perspective structural view illustrating a magnetic component assembly according to a first embodiment of the present disclosure and taken from a top perspective;

FIG. 2 is a perspective structural view illustrating the magnetic component assembly according to the first embodiment of the present disclosure and taken from a bottom perspective;

FIG. 3 is an exploded view illustrating the magnetic component assembly according to the first embodiment of the present disclosure;

FIG. 4 is s a longitudinal cross-sectional view the magnetic component assembly potted in the metal housing according to the first embodiment of the present disclosure;

FIG. 5 is a transverse cross-sectional view illustrating the magnetic component assembly potted in the metal housing according to the first embodiment of the present disclosure;

FIG. 6 is a perspective structural view illustrating a magnetic component assembly according to a second embodiment of the present disclosure and taken from a top perspective;

FIG. 7 is a perspective structural view illustrating the magnetic component assembly according to the second embodiment of the present disclosure and taken from a bottom perspective;

FIG. 8 is an exploded view illustrating the magnetic component assembly according to the second embodiment of the present disclosure;

FIG. 9 is s a longitudinal cross-sectional view the magnetic component assembly potted in the metal housing according to the second embodiment of the present disclosure;

FIG. 10 is a transverse cross-sectional view illustrating the magnetic component assembly potted in the metal housing according to the second embodiment of the present disclosure;

FIG. 11 is a perspective structural view illustrating a magnetic component assembly according to a third embodiment of the present disclosure and taken from a top perspective;

FIG. 12 is a perspective structural view illustrating the magnetic component assembly according to the third embodiment of the present disclosure and taken from a bottom perspective;

FIG. 13 is an exploded view illustrating the magnetic component assembly according to the third embodiment of the present disclosure;

FIG. 14 is s a longitudinal cross-sectional view the magnetic component assembly potted in the metal housing according to the third embodiment of the present disclosure;

FIG. 15 is a transverse cross-sectional view illustrating the magnetic component assembly potted in the metal housing according to the third embodiment of the present disclosure;

FIG. 16 is a perspective structural view illustrating a magnetic component assembly according to a fourth embodiment of the present disclosure and taken from a top perspective;

FIG. 17 is a perspective structural view illustrating the magnetic component assembly according to the fourth embodiment of the present disclosure and taken from a bottom perspective;

FIG. 18 is an exploded view illustrating the magnetic component assembly according to the fourth embodiment of the present disclosure;

FIG. 19 is s a longitudinal cross-sectional view the magnetic component assembly potted in the metal housing according to the fourth embodiment of the present disclosure;

FIG. 20 is a transverse cross-sectional view illustrating the magnetic component assembly potted in the metal housing according to the fourth embodiment of the present disclosure;

FIG. 21 is a perspective structural view illustrating a magnetic component assembly according to a fifth embodiment of the present disclosure and taken from a top perspective;

FIG. 22 is a perspective structural view illustrating the magnetic component assembly according to the fifth embodiment of the present disclosure and taken from a bottom perspective;

FIG. 23 is an exploded view illustrating the magnetic component assembly according to the fifth embodiment of the present disclosure;

FIG. 24 is s a longitudinal cross-sectional view the magnetic component assembly potted in the metal housing according to the fifth embodiment of the present disclosure;

FIG. 25 is a transverse cross-sectional view illustrating the magnetic component assembly potted in the metal housing according to the fifth embodiment of the present disclosure;

FIG. 26 is a perspective structural view illustrating a magnetic component assembly according to a sixth embodiment of the present disclosure and taken from a top perspective;

FIG. 27 is a perspective structural view illustrating the magnetic component assembly according to the sixth embodiment of the present disclosure and taken from a bottom perspective;

FIG. 28 is an exploded view illustrating the magnetic component assembly according to the sixth embodiment of the present disclosure;

FIG. 29 is s a longitudinal cross-sectional view the magnetic component assembly potted in the metal housing according to the sixth embodiment of the present disclosure; and

FIG. 30 is a transverse cross-sectional view illustrating the magnetic component assembly potted in the metal housing according to the sixth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “upper,” “lower,” “front,” “rear,” “left,” “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

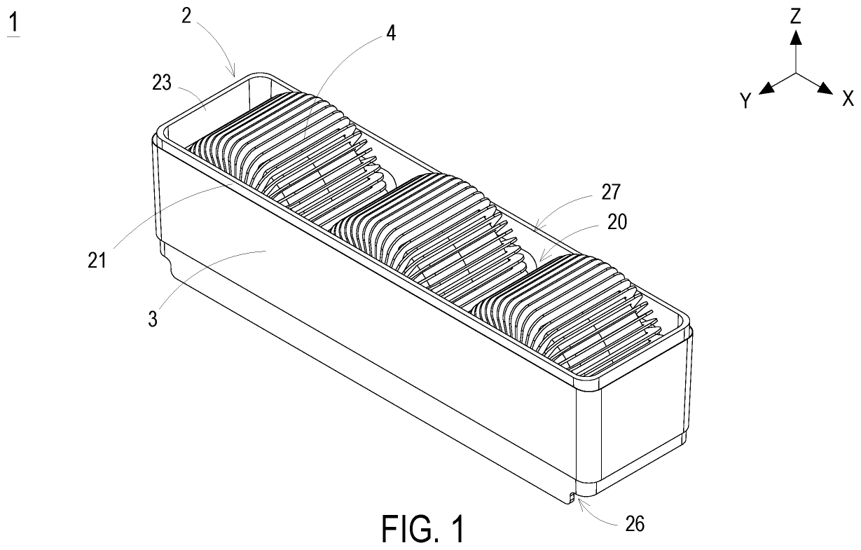

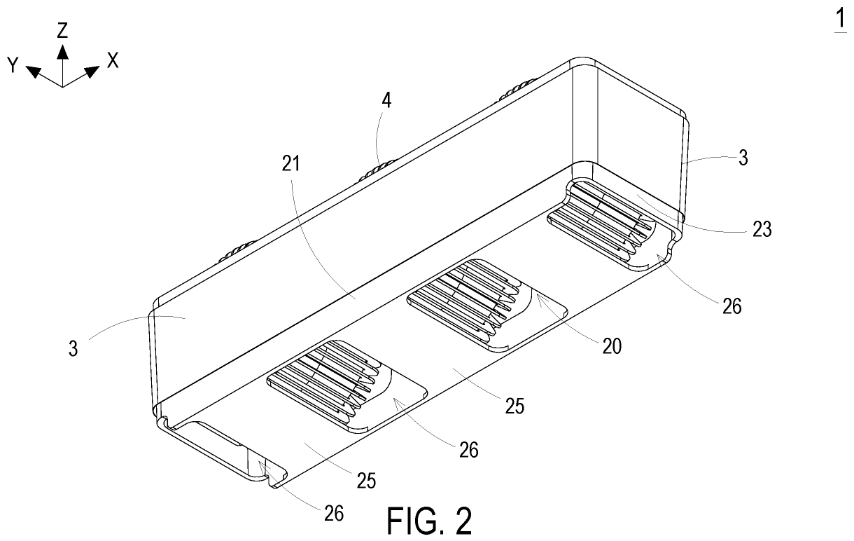

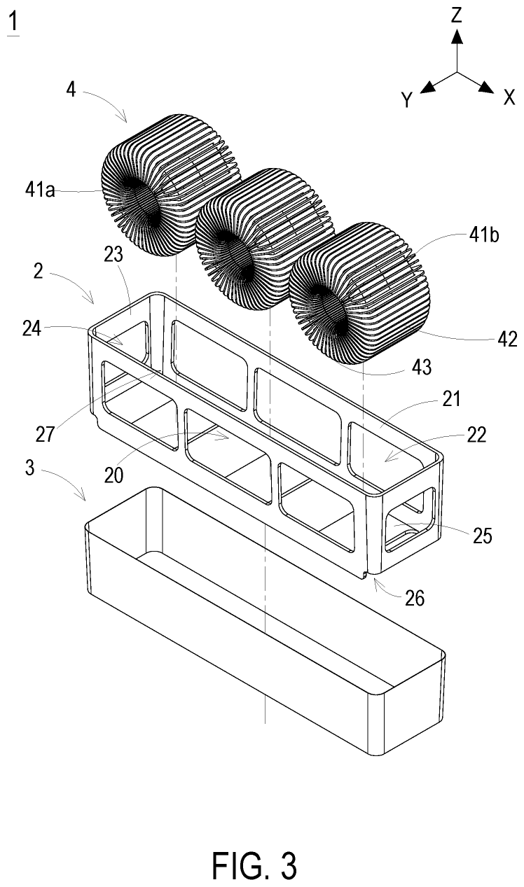

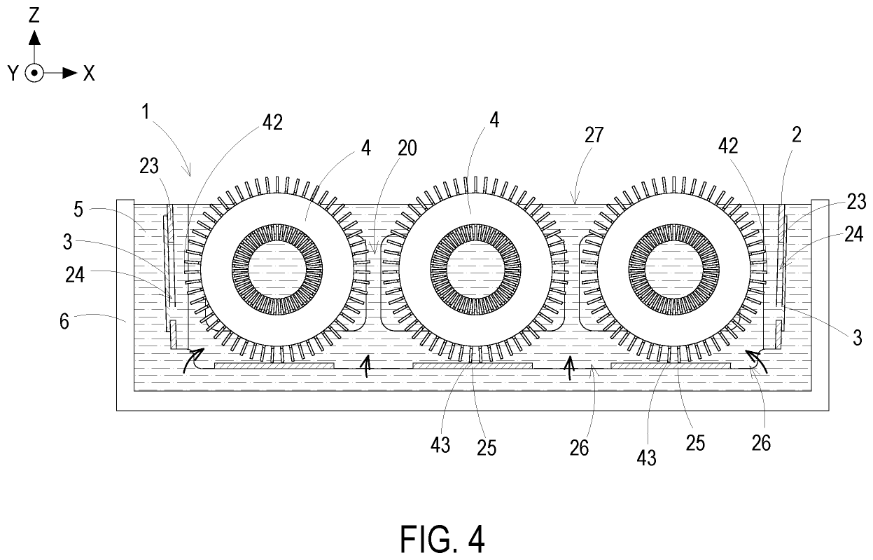

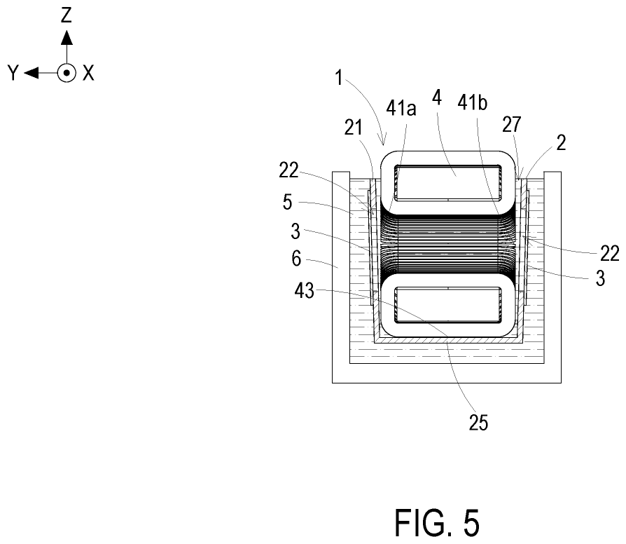

FIG. 1 is a perspective structural view illustrating a magnetic component assembly according to a first embodiment of the present disclosure and taken from a top perspective. FIG. 2 is a perspective structural view illustrating the magnetic component assembly according to the first embodiment of the present disclosure and taken from a bottom perspective. FIG. 3 is an exploded view illustrating the magnetic component assembly according to the first embodiment of the present disclosure. FIG. 4 is s a longitudinal cross-sectional view the magnetic component assembly potted in the metal housing according to the first embodiment of the present disclosure. FIG. 5 is a transverse cross-sectional view illustrating the magnetic component assembly potted in the metal housing according to the first embodiment of the present disclosure. In the embodiment, the magnetic component assembly 1 includes a magnetic component 4, a plastic frame 2 and an insulation tape 3. The plastic frame 2 includes a top opening 27, a bottom plate 25 and an outer peripheral wall. The outer peripheral wall is disposed around the bottom plate 25 to form an accommodation space 20. In an embodiment, the plastic frame 2 for example is a rectangular frame or a cube frame, and includes a pair of first sidewalls 21 and a pair of second sidewalls 23. The bottom plate 25 is connected to the pair of first sidewalls 21 and the pair of second sidewalls 23. The pair of first sidewalls 21 and the pair of second sidewalls 23 are connected to end to end to form the accommodation space 20. The top opening 27 is in communication with the accommodation space 20.

Certainly, the external structure of the plastic frame 2 of the present disclosure is adjustable according to the practical requirements. The accommodation space 20 formed in the plastic frame 2 is suitable for the magnetic component 4. In an embodiment, the magnetic component 4 for example is a PFC inductor in a power factor correction (PFC) circuit of an on-board charger power supply or a transformer in a DCDC conversion circuit of an on-board charger power supply. In other embodiments, the magnetic component 4 for example is an inductor or a transformer of the charging pile. Certainly, the present disclosure is not limited thereto. The magnetic component 4 is accommodated in the accommodation space 20 through the top opening 27. In some embodiments, the magnetic component 4 is partly or completely accommodated in the accommodation space 20 of the plastic frame 2. The present disclosure is not limited thereto. In the embodiment, the magnetic component 4 for example is in a shape of a cylinder, which includes a first side 41a and a second side 41b opposite to each other, and an outer ring surface 42. The first side 41a and the second side 41b are connected through the outer ring surface 42. Notably, the cylindrical structure is not the physical shape of the magnetic component 4, but the overall appearance shape. Certainly, the outer shape of the magnetic component 4 can also be a rectangular parallelepiped structure. The present disclosure is not limited thereto. In the embodiment, three magnetic components 4 are arranged in the accommodation space 20 and arranged along the pair of first sidewalls 21 (i.e., the X axial direction). In other embodiments, only one magnetic component 4 is disposed in the accommodation space 20. The number of the magnetic component 4 accommodated in the plastic frame 2 is adjustable according to the practical requirements. The present disclosure is not limited thereto. Each magnetic component 4 includes at least one adjacent side. In an embodiment, the at least one adjacent side of the magnetic component 4 is a part or all of the first side 41a, or/and a part or all of the second side 41b. For example, in the embodiment shown in FIG. 3, the magnetic component 4 arranged in the middle includes two adjacent sides, and the two adjacent sides are a part of the first side 41a and a part of the second side 41b respectively. Certainly, the magnetic component 4 may include only one adjacent side. The definition of the adjacent sides will be described in conjunction with the window on the sidewall and the insulation tape. In the embodiment, the plastic frame 2 includes windows 22, 24 and a through opening 26. The window 22 is arranged on the pair of first sidewalls 21, and the window 24 is arranged on the pair of second sidewalls 23. The window 22 is spatially corresponding to the first side 41a and the second side 41b of the magnetic component 4, and the window 24 is spatially corresponding to a part of the outer ring surface 42 of the magnetic component 4. In some other embodiments, only one window is disposed on the plastic frame 2. In the embodiment, the magnetic component assembly 1 further includes an insulation tape 3 attached to the plastic frame 2 and covering at least one window such as windows 22, 24, so as to shield at least one adjacent side of the magnetic component 4. As shown in FIG. 1 and FIG. 3, the magnetic component 4 in the middle position is further used for illustration. The magnetic component 4 is partially accommodated in the accommodation space 20. That is, a part of the magnetic component 4 is placed outside the plastic frame 2, and the pair of windows 22 are disposed on the pair of the first sidewalls 21, respectively, and spatially corresponding to the first side 41a and the second side 41b of the magnetic component 4. The insulation tape 3 is attached to the plastic frame 2 and covers the pair of windows 22 to shield the part of first side 41a and the second side 41b of the magnetic component 4. In other words, in the embodiment, the adjacent side of the magnetic component 4 in the middle position includes the part of the first side 41a and the second side 41b of the magnetic component 4 that is shielded due to the insulation tape 3 covering the windows 22. Notably, a partial structure of the magnetic component 4 in the middle position is placed outside the plastic frame 2, the adjacent side of the magnetic component 4 needs to be spatially corresponding to the windows 22 on the first sidewalls 21, and the insulation tape 3 attached to the plastic frame 2 can shield the adjacent sides of the magnetic component 4, so that two adjacent sides of the magnetic component 4 are the partial structure of the first side 41a and part of the second side 41b, respectively. In other embodiments, the magnetic component 4 is completely accommodated in the accommodation space 20. When the window is disposed on the first sidewall 21 or/and the second side wall 23, it allows to show all of the first side or/and all of the second side in the viewing direction from the window toward the magnetic component 4. That is, the insulation tape 3 attached to the plastic frame 2 completely shields the first side 41a or/and the second side 41b of the magnetic component 4. At this time, the adjacent side of the magnetic component 4 is the entire first side 41a or the entire second side 41b. It can be understood that the size of the window can be equal to or larger than the size of the magnetic component 4 in the viewing direction from the window toward the magnetic component 4. When the magnetic component 4 passes through the top opening 27 and is vertically placed into the accommodation space 20 with a part of the outer ring surface 42 facing down, the part or all of the first side 41a and the part or all of the second side 41b facing the at least one windows of the plastic frame 2 are regarded as the adjacent sides of the magnetic component 4. Moreover, in the embodiment, when the three magnetic components 4 are arranged along the pair of first sidewalls 21 (i.e., the X axial direction), the part of the outer ring surface 42 facing the corresponding window 24 and shielded by the insulation tape 23 is also regarded as the adjacent side of the magnetic component 4. This can be found in the magnetic components 4 arranged adjacent to the left and the right of the plastic frame 2. In the other words, the adjacent side further includes the part of the outer ring surface 42 shielded by the insulation type 23 on the windows 24. In the embodiment, the plastic frame 2 includes a plurality of windows 22, 24 disposed around the pair of first sidewalls 21 and the pair of second sidewalls 23 of the plastic frame 2. In addition, the insulation tape 3 is looped around and attached to the outer peripheral wall of the plastic frame 2, such as the pair of first sidewalls 21 and the pair of second side walls 23, so as to cover the windows 22, 24, and shield the adjacent side of the magnetic component 4 corresponding to the plastic frame 2. Certainly, in other embodiments, the window is disposed on the first sidewall 21 or the second sidewall 23, merely. The present disclosure is not limited thereto.

In the embodiment, the outer ring surface 42 of the magnetic component 4 has a bottom 43. The bottom 43 is arranged adjacent to the bottom plate 25 of the plastic frame 2, and the at least one through opening 26 of the plastic frame 2 is disposed on the bottom plate 25. In order to increase the creepage distance and meet the requirements of safety regulations, the bottom 43 of the outer ring surface 42 and the through opening 26 on the bottom plate 25 are misaligned with each other. That is, the bottom 43 and the through opening 26 are not overlapped in the viewing direction of the Z axis. On the other hand, in the embodiment, the magnetic component assembly 1 is configured to be accommodated in a metal housing 6 and potted in a heat dissipation adhesive 5, so that the heat generated from the magnetic component assembly 1 is dissipated through the metal housing 6. In a specific embodiment, the magnetic component assembly 1 is partially or completely accommodated in the metal housing 6.

Correspondingly, the magnetic component assembly 1 is partially or completely potted in the heat dissipation adhesive 5. The present disclosure is not limited thereto. Certainly, in other embodiment, the heat dissipation adhesive 5 is omitted. In the embodiment, the heat dissipation adhesive 5 is a thermal conductive material filled between the magnetic component 4 and the plastic frame 2, and between the plastic frame 2 and the metal housing 5. The heat dissipation adhesive 5 has the thermal conductivity >0.5 W/mK, and it is helpful for transferring the heat inside the magnetic component 4 through the first side 41a, the second side 41b, the windows 22 and the insulation tape 3 to the wall of the metal housing 6. In an embodiment, the heat dissipation method of the metal housing 6 is water cooling or air cooling. The present disclosure is not limited thereto. In an embodiment, the heat dissipation adhesive 5 includes a general thermal conductive adhesive, a thermal conductive silicone grease, and a phase-change material. In other embodiment, the heat dissipation adhesive 5 is the thermal conductive adhesive and the thermal conductive silicone grease mixed with granular or powdery particles of thermal conductive materials. During the producing process, the internal air bubbles are removed by means of vacuuming or standing to avoid hindering the heat transfer. Certainly, the present disclosure is not limited thereto, and not redundantly described herein.

Notably, in the embodiment, the through opening 26 of the plastic frame 2 is disposed on the bottom plate 25. The heat dissipation adhesive 5 is introduced into the accommodation space 20 through the at least one through opening 26 and encapsulated the magnetic component 4 to form a potted body. The insulation tape 3 is pre-attached to the outer peripheral wall of the plastic frame 2, such as the pair of first sidewalls 21 and the pair of second sidewalls 23 to cover the windows 22, 24. When the metal housing 6 and the heat dissipation adhesive 5 are installed, the heat dissipation adhesive 5 for potting is added into the metal housing 6 firstly, and then the plastic frame 2 with insulation tape 3 pre-attached thereon is placed into the metal housing 6. At this time, the heat dissipation adhesive 5 for potting is introduced into the accommodation space 20 through the through opening 26 on the bottom plate 25 of the plastic frame 2. Thereafter, the magnetic component 4 is placed into the accommodation space 20 in the plastic frame 2 through the top opening 27. When the heat dissipation adhesive 5 is fully contacted with the magnetic component 4 and cured to fix the magnetic component 4, the installation is completed. Certainly, the assembling procedure of the magnetic component assembly 1, the metal housing 6 and the heat dissipation adhesive 5 is not limited thereto. In the embodiment, the magnetic component assembly 1 includes the windows 22, 24 and the through opening 26 disposed on the plastic frame 2, and the insulation tape 3 covering the windows 22, 24, and the heat dissipation adhesive 5 for potting is introduced through the through opening 26, so that the insulation and heat dissipation problems of the magnetic component 4 are solved at the same time. Since the magnetic component assembly 1 is applied in the metal housing 6 and potted with the heat dissipation adhesive 5, the requirements for low thermal resistance and high insulation level of the adjacent side of the magnetic component 4 are particularly stringent. Through the windows 22, 24 and the insulation tape 3 corresponding to the adjacent side of magnetic component 4, the thermal contact is formed, and it helps to further enhance the thermal transfer channel and meet the insulation requirements of the magnetic component 4 at the same time. In this way, the part of the magnetic component 4 which is close to the metal housing 6 and less than safety creepage distance also meets the insulation requirements. In addition, the arrangement of the portion of plastic frame 2 without the windows and the through openings is helpful for auxiliary heat dissipation. The PFC inductor operated at full load is taken as an example. Compared with the conventional assembly structure in which the magnetic components are wrapped with insulation tape, the combination of the windows 22, 24 of the plastic frame 2 and the insulation tape 3 are used in the present disclosure to enhance the heat dissipation capability, and reduce the temperature rise of the entire device sufficiently. On the other hand, through the windows 22, 24 and the insulation tape 3 corresponding to the adjacent side of the magnetic component 4, it allows the magnetic component 4 to meet the insulation requirements. There is no need to increase the space of the metal housing 6, and the consumption of the heat dissipation adhesive 5 is small. In other embodiments, the magnetic component 4 can adopt thinner copper wire or a magnetic ring with greater loss. And the heat dissipation adhesive 5 with a larger thermal resistance is selected. Certainly, the present disclosure is not limited thereto, and not redundantly described herein.

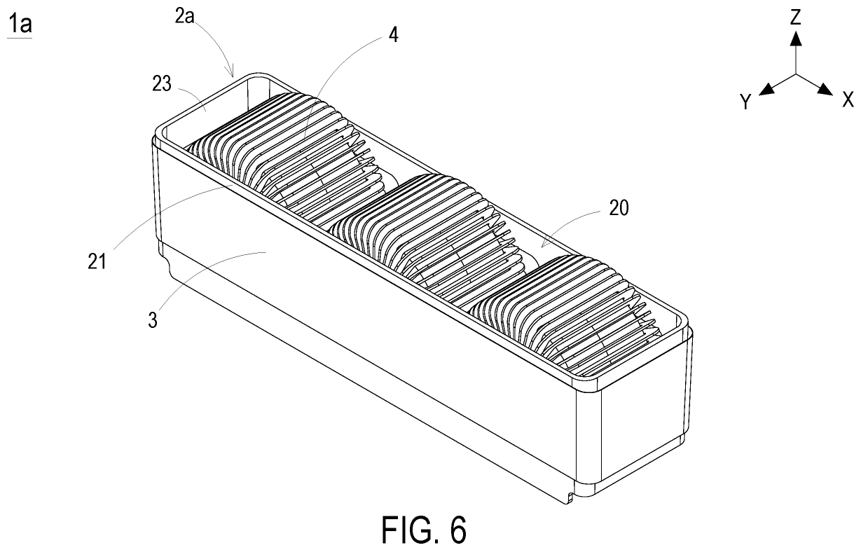

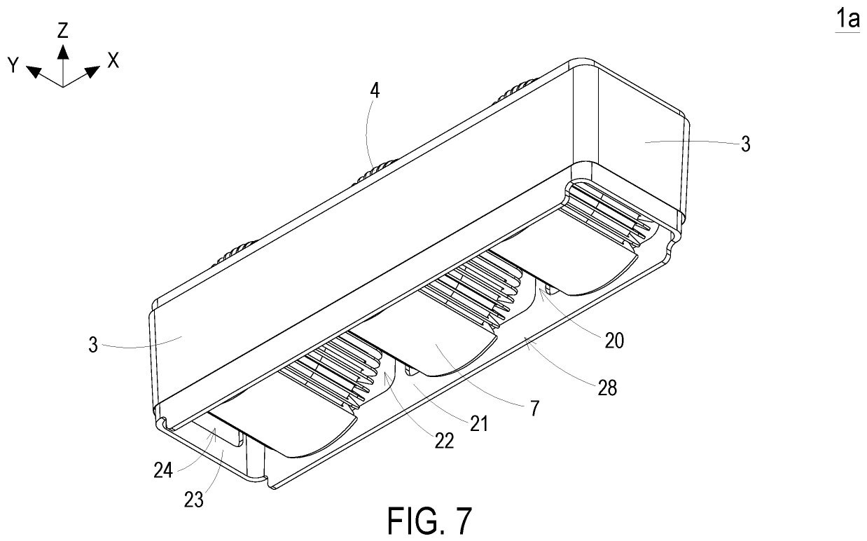

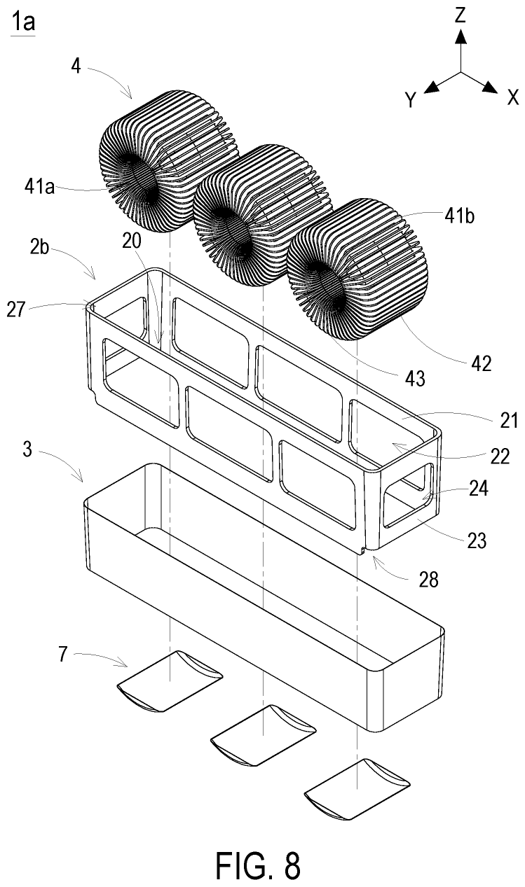

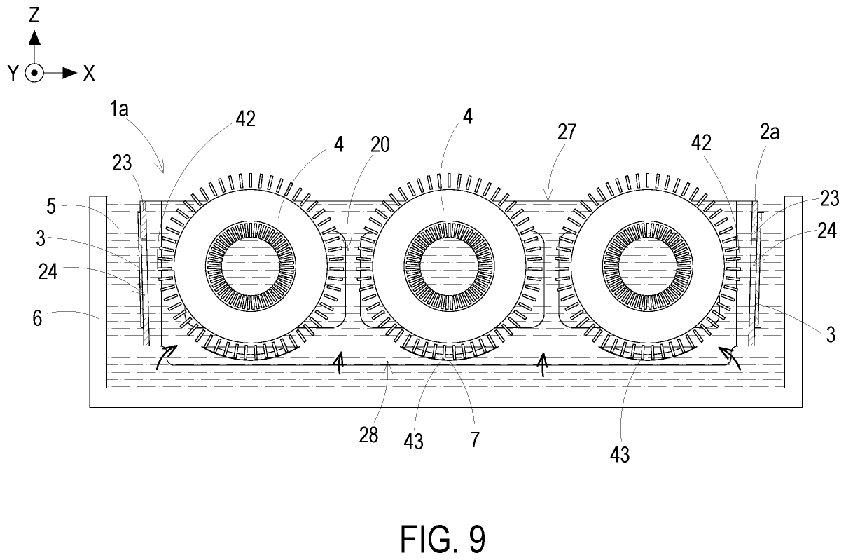

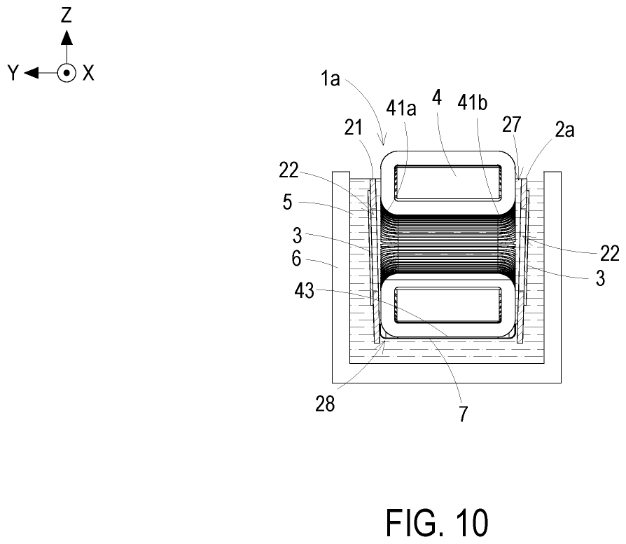

FIG. 6 is a perspective structural view illustrating a magnetic component assembly according to a second embodiment of the present disclosure and taken from a top perspective. FIG. 7 is a perspective structural view illustrating the magnetic component assembly according to the second embodiment of the present disclosure and taken from a bottom perspective. FIG. 8 is an exploded view illustrating the magnetic component assembly according to the second embodiment of the present disclosure. FIG. 9 is a longitudinal cross-sectional view the magnetic component assembly potted in the metal housing according to the second embodiment of the present disclosure. FIG. 10 is a transverse cross-sectional view illustrating the magnetic component assembly potted in the metal housing according to the second embodiment of the present disclosure. In the embodiment, the structures, elements and functions of the magnetic component assembly 1a are similar to those of the magnetic component assembly 1 of FIGS. 1 to 5, and are not redundantly described herein. In the embodiment, the magnetic component assembly 1a includes a magnetic component 4, a plastic frame 2a, an insulation tape 3 and an auxiliary insulation tape 7. The plastic frame 2a includes a top opening 27, a bottom opening 28 and an outer peripheral wall. The outer peripheral wall forms the accommodation space 20. The top opening 27 and the bottom opening 28 are disposed opposite to each other and in communication with the accommodation space 20. In an embodiment, the plastic frame 2a is a rectangular frame or a cube frame, and includes a pair of first sidewalls 21 and a pair of second sidewalls 23. The pair of first sidewalls 21 and the pair of second sidewalls 23 are connected end to end to form the accommodation space 20. In the embodiment, the bottom opening 28 is defined as the at least one through opening. In the embodiment, three magnetic components 4 are arranged to be vertically accommodated in the accommodation space 20 with the part of the outer ring surface 42 facing downward, and arranged along the X axial direction. The part of the first side 41a and the second side 41b of each magnetic component 4 spatially corresponding to the window 22 of the plastic frame 2a and shielded by the insulation tape 3 is regarded as the adjacent side of the magnetic component. Similarly, the part of the outer ring surfaces 42 of the three magnetic components 4 disposed adjacent to the plastic frame 2a on the right and left sides, facing the window 24 and shielded by the insulation tape 3, also is regarded as the adjacent sides of the magnetic component 4. In the embodiment, the plastic frame 2a includes a plurality of windows 22, 24 surrounding the outer peripheral wall, such as the pair of first sidewalls 21 and the pair of second sidewalls 23 of the plastic frame 2a. In addition, the insulation tape 3 is looped around and attached to the outer peripheral wall of the plastic frame 2a, such as the pair of first sidewalls 21 and the pair of second side walls 23, so as to cover the windows 22, 24, and shield the adjacent sides of the magnetic component 4 corresponding to the plastic frame 2a. Through the windows 22, 24 and the insulation tape 3 corresponding to the adjacent sides of the magnetic component 4, the thermal contact is formed, and it helps to further enhance the thermal transfer channel and meet the insulation requirements of the magnetic component 4 at the same time.

In the embodiment, the bottom opening 28 of the plastic frame 2a is regarded as the at least one through opening. In addition to facilitating the introduction of the heat dissipation adhesive 5 into the accommodation space 20 during potting, the arrangement of the bottom opening 28 is further helpful for increasing the heat dissipation capability of the magnetic component 4 at the bottom 43 of the outer ring surface 42. In the embodiment, the magnetic component assembly 1a further includes an auxiliary insulation tape 7, which is attached to the bottom 43 of the outer ring surface 42 of the magnetic component 4. In this way, the magnetic component 4 is shielded in the direction of the at least one through opening (i.e., the bottom opening 28) facing the magnetic component 4, so as to meet the insulation requirements of the magnetic component 4 relative to the metal housing 6 in the direction of the Z axis. Certainly, the present disclosure is not limited thereto.

On the other hand, compared with the plastic frame 2, in the embodiment, the bottom opening 28 of the plastic frame 2a is used as the through opening, and it allows to introduce the heat dissipation adhesive 5 into the accommodation space 20 through the bottom opening 28. It facilitates to improve the installation efficiency of the magnetic component assembly 1a, the metal housing 6 and the heat dissipation adhesive 5. In an embodiment, the insulation tape 3 is pre-disposed around and attached to the first sidewalls 21 and the second sidewalls 23 of the plastic frame 2a to cover the windows 22, 24. Certainly, the installation sequence of the magnetic component 4, the plastic frame 2a, the heat dissipation adhesive 5 and the metal housing 6 is adjustable according to the practical requirements, and not redundantly described herein.

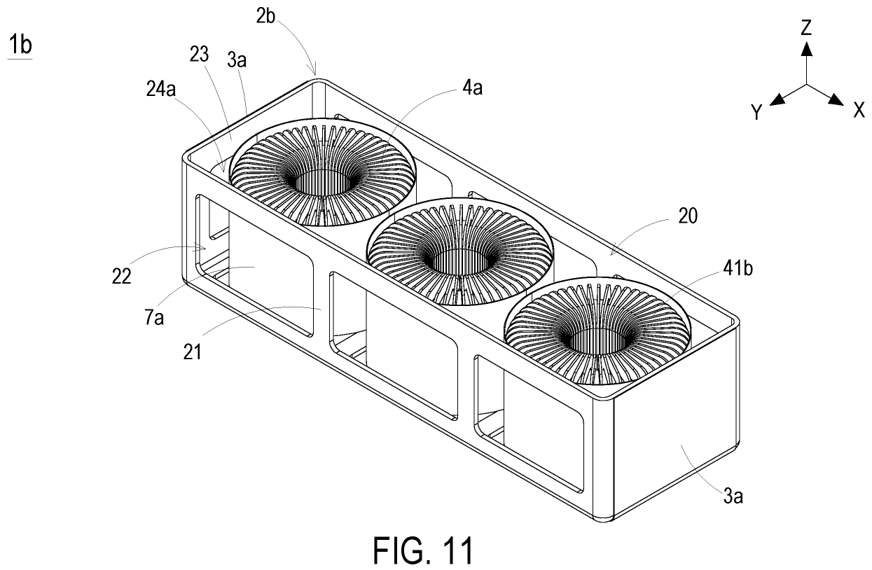

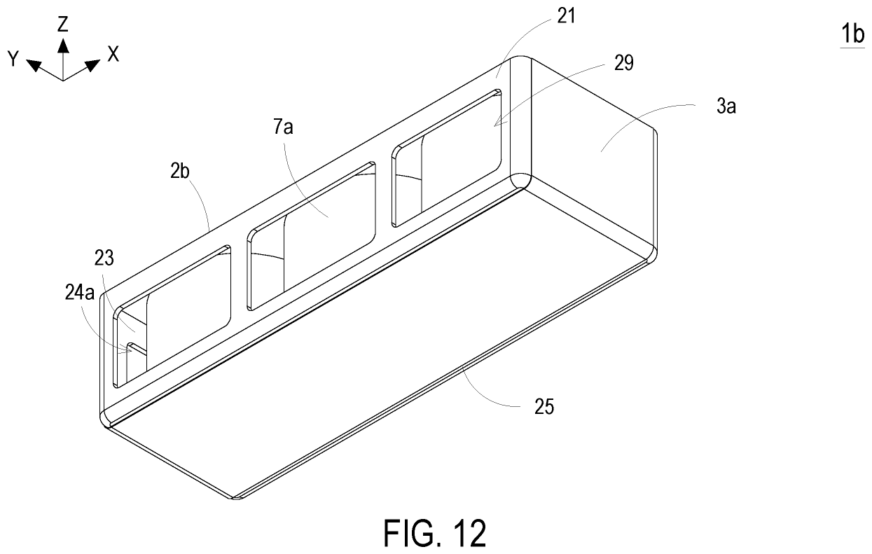

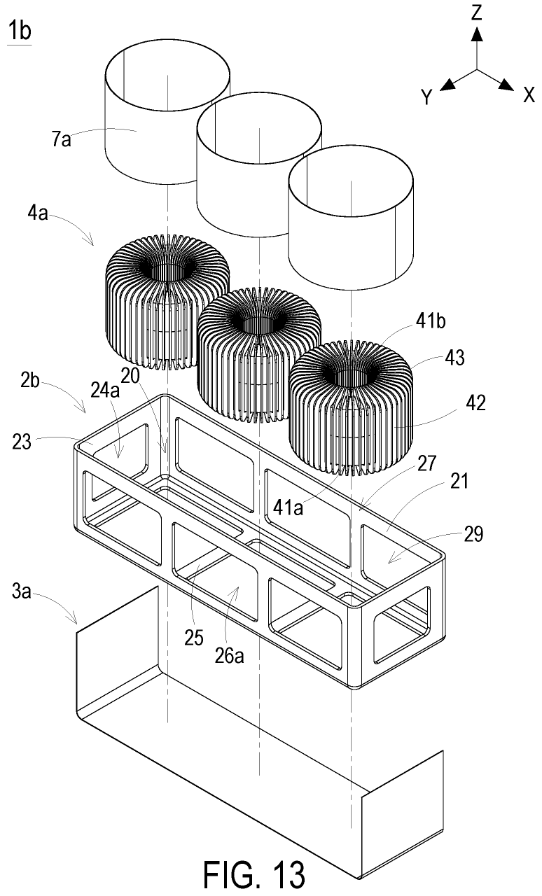

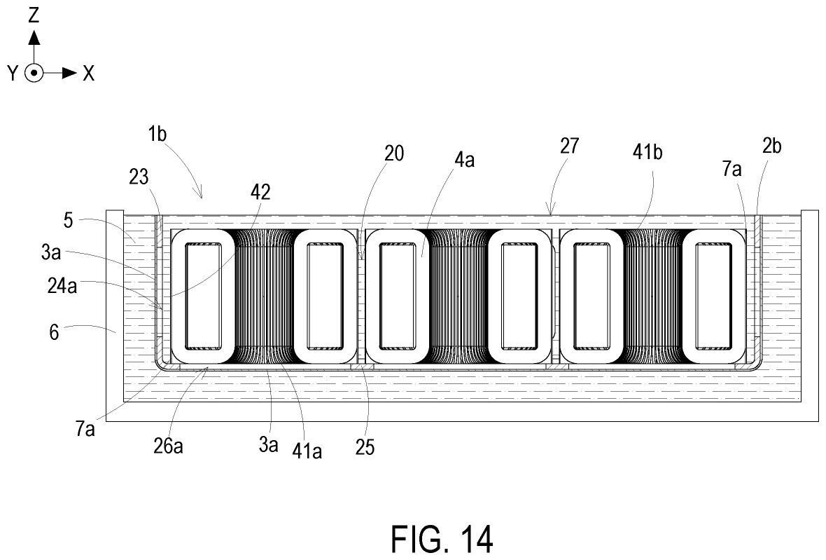

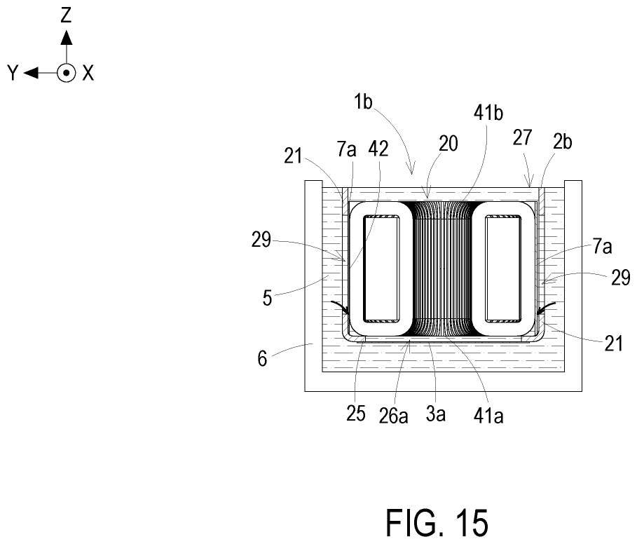

FIG. 11 is a perspective structural view illustrating a magnetic component assembly according to a third embodiment of the present disclosure and taken from a top perspective. FIG. 12 is a perspective structural view illustrating the magnetic component assembly according to the third embodiment of the present disclosure and taken from a bottom perspective. FIG. 13 is an exploded view illustrating the magnetic component assembly according to the third embodiment of the present disclosure. FIG. 14 is s a longitudinal cross-sectional view the magnetic component assembly potted in the metal housing according to the third embodiment of the present disclosure. FIG. 15 is a transverse cross-sectional view illustrating the magnetic component assembly potted in the metal housing according to the third embodiment of the present disclosure. In the embodiment, the structures, elements and functions of the magnetic component assembly 1b are similar to those of the magnetic component assembly 1 of FIGS. 1 to 5, and are not redundantly described herein. In the embodiment, the magnetic component assembly 1b includes a magnetic component 4a, a plastic frame 2b, an insulation tape 3a and an auxiliary insulation tape 7a. The plastic frame 2b includes a top opening 27, a bottom plate 25 and an outer peripheral wall. The outer peripheral wall forms the accommodation space 20. In an embodiment, the plastic frame 2b is a rectangular frame or a cube frame, and includes a pair of first sidewalls 21 and a pair of second sidewalls 23. The bottom plate 25 is connected to the pair of first sidewalls 21 and the pair of second sidewalls 23, and the pair of first sidewalls 21 and the pair of second sidewalls 23 are connected end to end to form the accommodation space 20. The top opening 27 is in communication with the accommodation space 20. In the embodiment, the magnetic component 4a is in a shape of a cylinder, which includes a first side 41a and a second side 41b opposite to each other, and an outer ring surface 42. The first side 41a and the second side 41b are connected to each other through the outer ring surface 42. In the embodiment, three magnetic components 4a are arranged along the X axial direction and horizontally accommodated in the accommodation space 20 of the plastic frame 2b through the top opening 27. For example, with the first side 41a facing down, the magnetic component 4a is accommodated in the accommodation space 20 through the top opening 27 of the plastic frame 2b. In other embodiments, the magnetic component 4a is accommodated in the accommodation space 20 through the top opening 27 of the plastic frame 2b with the second side 41b facing down. In the embodiment, each magnetic component 4a includes at least one adjacent side. The portion of the first side 41a of the magnetic component 4a that is spatially corresponding to the bottom plate 25 of the plastic frame 2b and shielded by the insulation tape 3a is regarded as the adjacent side of the magnetic component 4a. Similarly, the part of the outer ring surfaces 42 of the three magnetic components 4a disposed adjacent to the plastic frame 2b on the right and left sides, spatially corresponding to the outer peripheral wall of the plastic frame 2b, such as the first sidewalls 21 or/and the second sidewalls 23, and shielded by the insulation tape 3a, also is regarded as the adjacent sides of the magnetic component 4a.

In the embodiment, the plastic frame 2b includes windows 26a and through openings 29. The windows 26a are disposed on the bottom plate 25 and spatially corresponding to the partial or all of the first sides 41a of the magnetic component 4a. Namely, the windows 26a are spatially corresponding to the adjacent side of the magnetic component 4a. The through openings 29 of the plastic frame 2b are disposed on the outer peripheral wall, such as the first sidewall 21. In the embodiment, the outer ring surface 42 of the magnetic component 4a has a bottom 43, which is disposed adjacent to the outer peripheral wall, such as the first sidewall 21, and corresponding to the through opening 29 on the first sidewall 21. In other embodiments, the through opening 29 of the plastic frame 2b is disposed on the second sidewall 23. In the embodiment, the plastic frame 2b further includes opening 24a disposed on the outer peripheral wall where there is no through opening 29. For example, the openings 24a are disposed on the pair of second sidewalls 23. In the embodiment, the part of the outer ring surfaces 42 of the three magnetic components 4a disposed adjacent to the plastic frame 2b on the right and left sides, spatially corresponding to the opening 24a, and shielded by the insulation tape 3a, also is regarded as the adjacent sides of the magnetic component 4a. In other words, in the embodiment, the plastic frame 2b further includes a plurality of opening 24a disposed on the outer peripheral wall without the through opening 29 disposed thereon, such as the second sidewall 23. In addition, the insulation tape 3a is attached to the bottom plate 25 and the pair of the second sidewalls 23 of the plastic frame 2b, covers the windows 26, the openings 24a, and shields the adjacent sides of the magnetic components 4a corresponding to the plastic frame 2b. Notably, the function of the opening 24a in the embodiment is the same as that of the window 26a, but the position is different.

In the embodiment, the outer ring surface 42 of the magnetic component 4a is disposed adjacent to the outer peripheral wall of the plastic frame 2b, such as the first sidewalls 21 and the second sidewalls 23. In addition, the through opening 29 of the plastic frame 2b is disposed on the first sidewall 21. In order to increase the creepage distance and meet the requirements of safety regulations, the magnetic component assembly 1b further includes an auxiliary insulation tape 7a in form of wrapping the outer ring surface 42 of the magnetic component 4a to increase the creepage distance from the magnetic component 4a to the through opening 29. In that, the insulation performance of the magnetic component 4a relative to the metal housing 6 is guaranteed. In other embodiments, the functions of the opening 24a and the through opening 29 of the plastic frame 2b can be replaced with each other. For example, the insulation tape 3a can be attached to the bottom plate 25 of the plastic frame 2b and the pair of first sidewalls 21 to cover the window 26a and the through opening 29 and keep the opening 24a in communication. The outer ring surface 42 of each magnetic component 4a is covered with an auxiliary insulation tape 7a, which can ensure that the insulation performance of the magnetic component 4a relative to the metal housing 6 meets the requirements. Certainly, the present disclosure is not limited thereto. In other embodiments, the first sidewall 21 and/or the second sidewall 23 has the through opening 29 and additional openings disposed thereon, and the present disclosure is not limited thereto. In other embodiments, the first sidewall 21 and the second sidewall 23 have the through opening disposed thereon merely, and the present disclosure is not limited thereto.

In the embodiment, the through opening 29 of the plastic frame 2b is disposed on the first sidewall 21. The heat dissipation adhesive 5 is introduced into the accommodation space 20 through the at least one through opening 29 and encapsulated the magnetic component 4 to form a potted body. The insulation tape 3a for example is pre-attached to the bottom plate 25 and the pair of second sidewalls 23 of the plastic frame 2b to cover the windows 26a and the opening 24a. The magnetic component 4a is covered with the auxiliary insulation tape 7a on the outer ring surface 42 in advance. When the magnetic component 4a is installed with the metal housing 6 and the heat dissipation adhesive 5, the heat dissipation adhesive 5 for potting is added into the metal housing 6 firstly, and then the plastic frame 2b with insulation tape 3a pre-attached thereon is placed into the metal housing 6. At this time, the heat dissipation adhesive 5 for potting is introduced into the accommodation space 20 through the through opening 29 on the first sidewall 21 of the plastic frame 2b. Thereafter, the magnetic component 4a with the first side 41a facing the bottom plate 25 is placed into the accommodation space 20 in the plastic frame 2b through the top opening 27. When the heat dissipation adhesive 5 is fully contacted with the magnetic component 4a and cured to fix the magnetic component 4a, the installation is completed. Certainly, the assembling procedure of the magnetic component assembly 1b, the metal housing 6 and the heat dissipation adhesive 5 is not limited thereto. In the embodiment, the magnetic component assembly 1b includes the windows 26a, the openings 24a and the through opening 29 disposed on the plastic frame 2b, and the insulation tape 3a covering the windows 26a and the opening 24a, and the heat dissipation adhesive 5 for potting is introduced through the through opening 29, so that the insulation and heat dissipation problems of the magnetic component 4a are solved at the same time. Certainly, the present disclosure is not limited thereto.

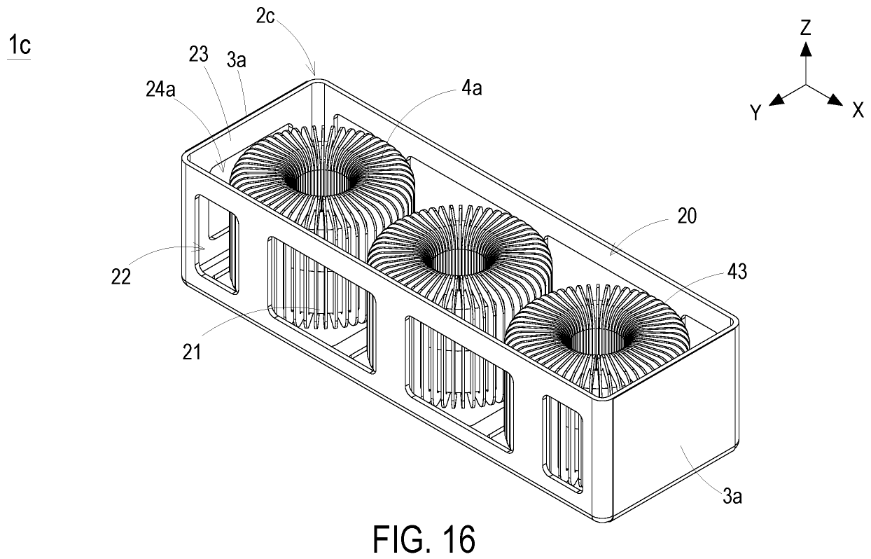

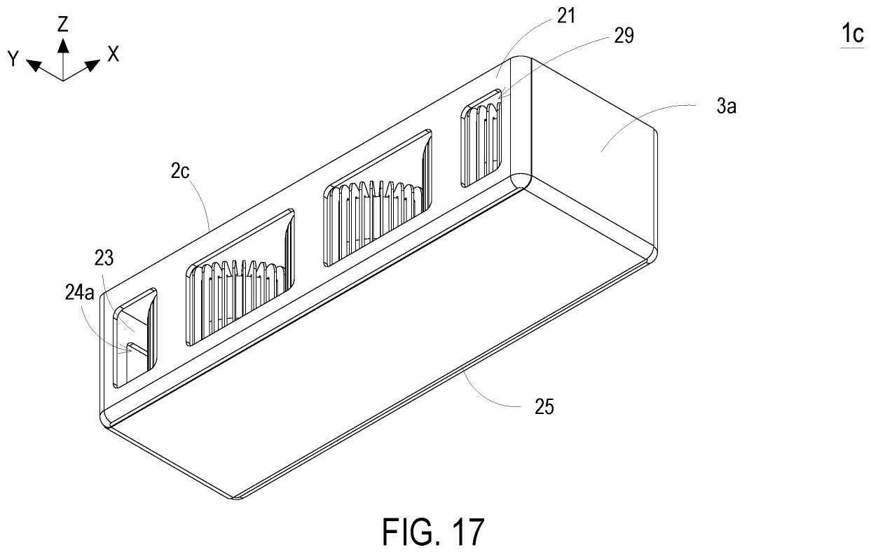

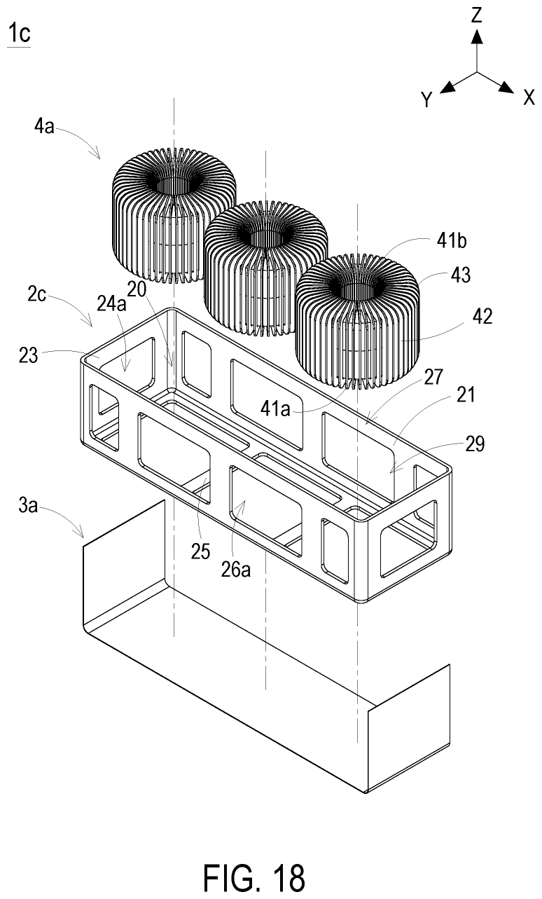

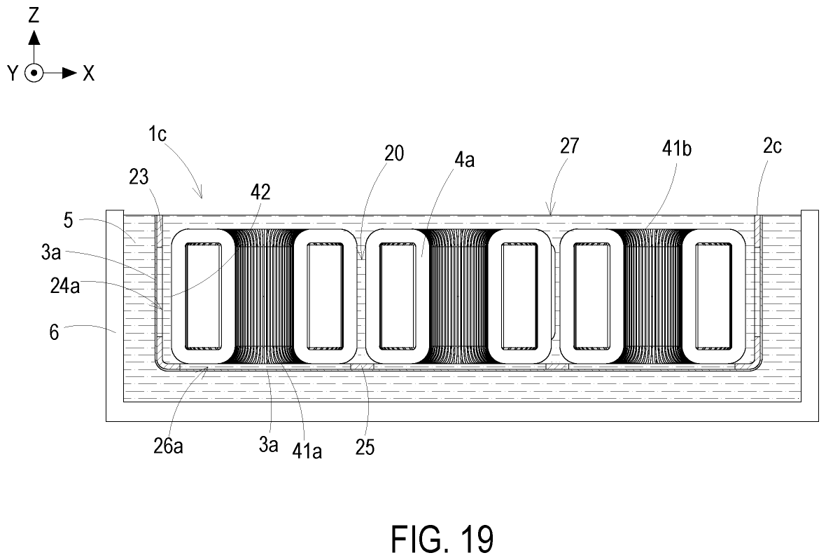

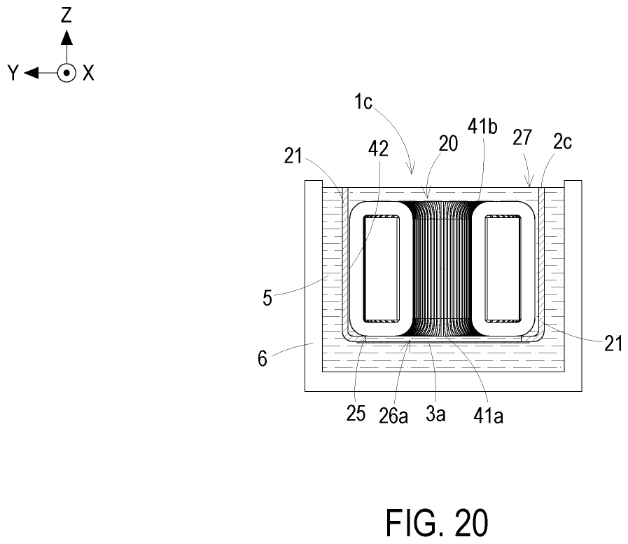

FIG. 16 is a perspective structural view illustrating a magnetic component assembly according to a fourth embodiment of the present disclosure and taken from a top perspective. FIG. 17 is a perspective structural view illustrating the magnetic component assembly according to the fourth embodiment of the present disclosure and taken from a bottom perspective. FIG. 18 is an exploded view illustrating the magnetic component assembly according to the fourth embodiment of the present disclosure. FIG. 19 is s a longitudinal cross-sectional view the magnetic component assembly potted in the metal housing according to the fourth embodiment of the present disclosure. FIG. 20 is a transverse cross-sectional view illustrating the magnetic component assembly potted in the metal housing according to the fourth embodiment of the present disclosure. In the embodiment, the structures, elements and functions of the magnetic component assembly 1c are similar to those of the magnetic component assembly 1b of FIGS. 10 to 15, and are not redundantly described herein. In the embodiment, the magnetic component assembly 1c includes a magnetic component 4a, a plastic frame 2c and an insulation tape 3a. The plastic frame 2c includes a top opening 27, a bottom plate 25 and an outer peripheral wall. The outer peripheral wall forms the accommodation space 20. In an embodiment, the plastic frame 2c is a rectangular frame or a cube frame, and includes a pair of first sidewalls 21 and a pair of second sidewalls 23. The bottom plate 25 is connected to the pair of first sidewalls 21 and the pair of second sidewalls 23, and the pair of first sidewalls 21 and the pair of second sidewalls 23 are connected end to end to form the accommodation space 20. The top opening 27 is in communication with the accommodation space 20. In the embodiment, the magnetic component 4a is in a shape of a cylinder, which includes a first side 41a and a second side 41b opposite to each other, and an outer ring surface 42. The first side 41a and the second side 41b are connected to each other through the outer ring surface 42. In the embodiment, three magnetic components 4a are arranged along the X axial direction and horizontally accommodated in the accommodation space 20 through the top opening 27. For example, with the first side 41a facing down, the magnetic component 4a is accommodated in the accommodation space 20 through the top opening 27 of the plastic frame 2c. In other embodiments, the magnetic component 4a is accommodated in the accommodation space 20 through the top opening 27 of the plastic frame 2c with the second side 41b facing down. In the embodiment, each magnetic component 4a includes at least one adjacent side. The part of the first side 41a of the magnetic component 4a that is spatially corresponding to the bottom plate 25 of the plastic frame 2c and shielded by the insulation tape 3a is regarded as the adjacent side of the magnetic component 4a. The part of the outer ring surfaces 42 of the three magnetic components 4a are disposed adjacent to the plastic frame 2c on the right and left sides, spatially corresponding to the outer peripheral wall of the plastic frame 2c, such as the first sidewalls 21 or/and the second sidewalls 23, and shielded by the insulation tape 3a, also is regarded as the adjacent sides of the magnetic component 4a.

In the embodiment, the plastic frame 2c includes windows 26a and through openings 29. The windows 26a are disposed on the bottom plate 25 and spatially corresponding to the partial or all of the first sides 41a of the magnetic component 4a. Namely, the windows 26a are spatially corresponding to the adjacent side of the magnetic component 4a. The through openings 29 of the plastic frame 2c are disposed on the outer peripheral wall, such as the first sidewalls 21. In the embodiment, the outer ring surface 42 of the magnetic component 4a has a bottom 43, which is disposed adjacent to the outer peripheral wall, such as the first sidewalls 21, and misaligned with the through openings 29 on the first sidewall 21. Namely, the bottom 43 of the magnetic component 4a and the through opening 29 are not overlapped in the viewing direction of the Y axis which can increase the creepage distance and meet safety requirements. In some embodiments, the plastic frame 2c further includes openings 24a disposed on the outer peripheral wall without the through opening 29, such as the second sidewall 23. In the embodiment, the part of the outer ring surfaces 42 of the three magnetic components 4a disposed adjacent to the plastic frame 2c on the right and left sides, spatially corresponding to the opening 24a, and shielded by the insulation tape 3a, also is regarded as the adjacent sides of the magnetic component 4a. In the embodiment, the function of the opening 24a is the same as that of the window 26a, but the position is different.

In the embodiment, the outer ring surface 42 of the magnetic component 4a is disposed adjacent to the outer peripheral wall of the plastic frame 2c, such as the first sidewalls 21 and the second sidewalls 23. In addition, the through opening 29 of the plastic frame 2c is disposed on the first sidewall 21. In the embodiment, the outer ring surface 42 of the magnetic component 4a is disposed adjacent to the first sidewall 21 of the plastic frame 2c, and a part of the outer ring surface 42 (the bottom 43) of the magnetic component 4a disposed adjacent to the first sidewall 21 of the plastic frame 2c is further misaligned with the through opening 29 on the first sidewall 21 to increase the creepage distance from the magnetic component 4a to the through opening 29. When the creepage distance from the outer ring surface 42 of the magnetic component 4a to the through opening 29 meets the safety requirements, the magnetic component assembly 1c can omit the auxiliary insulation tape 7a. Certainly, the present disclosure is not limited thereto.

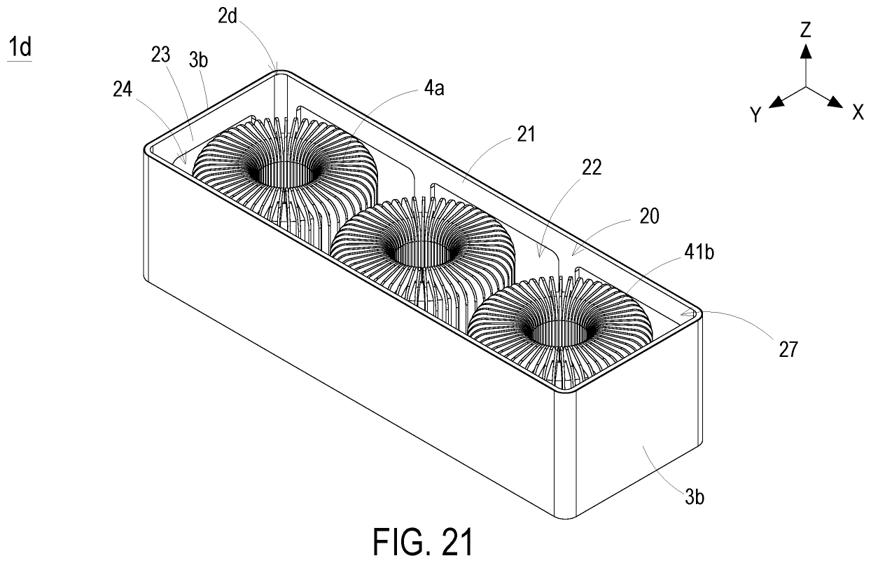

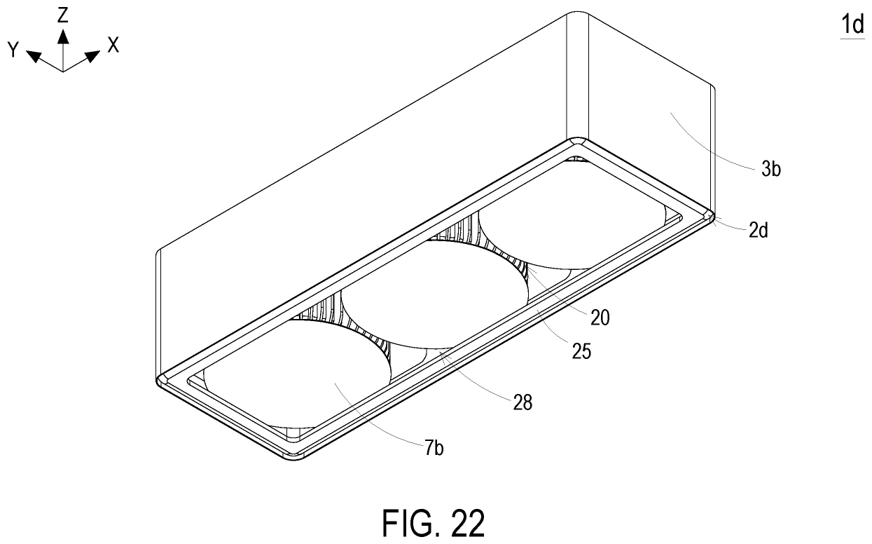

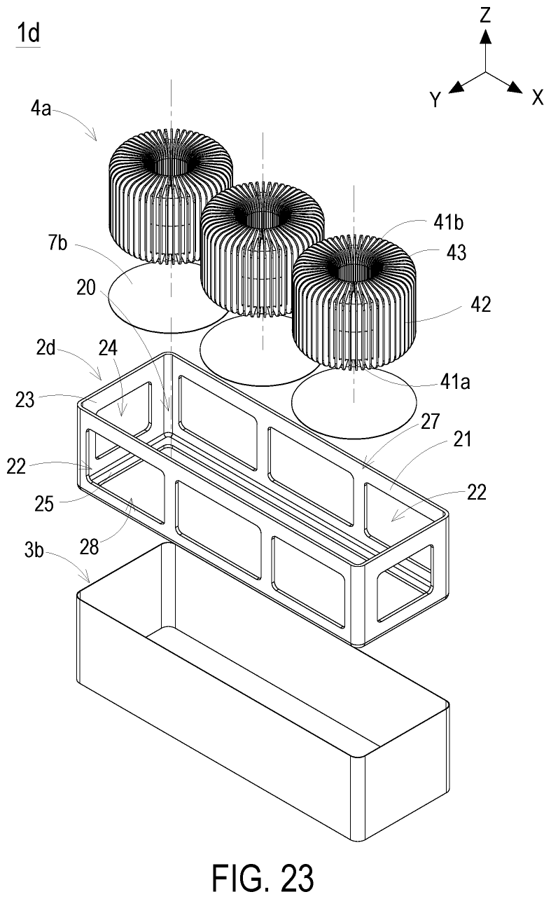

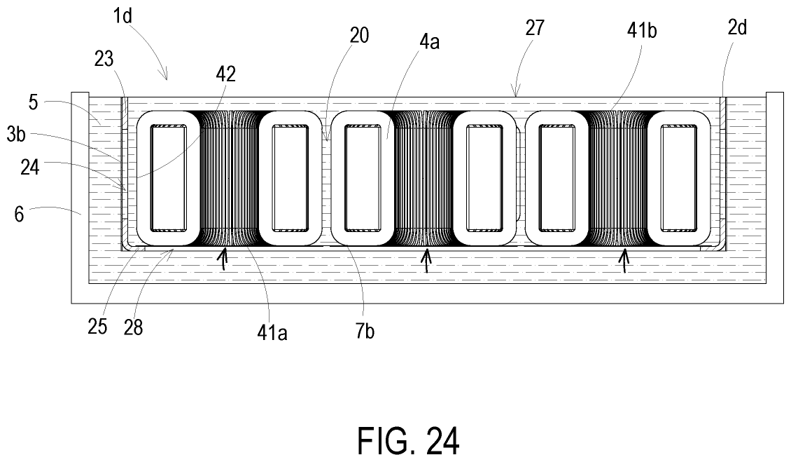

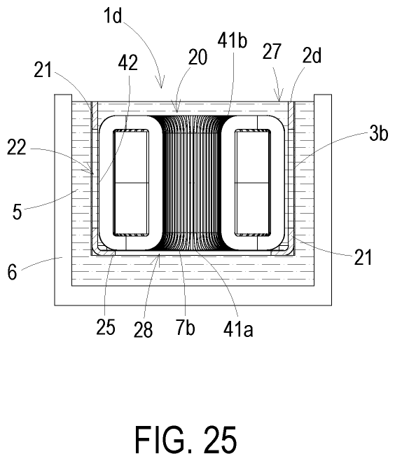

FIG. 21 is a perspective structural view illustrating a magnetic component assembly according to a fifth embodiment of the present disclosure and taken from a top perspective. FIG. 22 is a perspective structural view illustrating the magnetic component assembly according to the fifth embodiment of the present disclosure and taken from a bottom perspective. FIG. 23 is an exploded view illustrating the magnetic component assembly according to the fifth embodiment of the present disclosure. FIG. 24 is s a longitudinal cross-sectional view the magnetic component assembly potted in the metal housing according to the fifth embodiment of the present disclosure. FIG. 25 is a transverse cross-sectional view illustrating the magnetic component assembly potted in the metal housing according to the fifth embodiment of the present disclosure. In the embodiment, the structures, elements and functions of the magnetic component assembly 1d are similar to those of the magnetic component assembly 1a of FIGS. 6 to 10, and are not redundantly described herein. In the embodiment, the magnetic component assembly 1d includes a magnetic component 4a, a plastic frame 2d, an insulation tape 3b and an auxiliary insulation tape 7b. The plastic frame 2d includes a top opening 27, a bottom opening 28 and an outer peripheral wall. The outer peripheral wall forms the accommodation space 20. In an embodiment, the plastic frame 2d is a rectangular frame or a cube frame, and includes a pair of first sidewalls 21 and a pair of second sidewalls 23. The pair of first sidewalls 21 and the pair of second sidewalls 23 are connected end to end to form the accommodation space 20. The top opening 27 and the bottom opening 28 are disposed opposite to each other and in communication with the accommodation space 20. In the embodiment, the magnetic component 4a is in a shape of a cylinder, which includes a first side 41a and a second side 41b opposite to each other, and an outer ring surface 42. The first side 41a and the second side 41b are connected end to end through the outer ring surface 42. In the embodiment, three magnetic components 4a are arranged along the X axial direction and horizontally accommodated in the accommodation space 20 of the plastic frame 2d through the top opening 27. For example, with the first side 41a facing down, the magnetic component 4a is accommodated in the accommodation space 20 through the top opening 27 of the plastic frame 2d. In other embodiments, the magnetic component 4a is accommodated in the accommodation space 20 through the top opening 27 of the plastic frame 2d with the second side 41b facing down. In the embodiment, the bottom opening 28 is regarded as the at least one through opening 28. The part of the outer ring surface 42 of each magnetic component 4a spatially corresponding to the window 22 of the plastic frame 2d and shielded by the insulation tape 3b is regarded as the adjacent side of the magnetic component. Similarly, the part of the outer ring surfaces 42 of the three magnetic components 4a disposed adjacent to the plastic frame 2d on the right and left sides, spatially corresponding to the windows 24, and shielded by the insulation tape 3b, also is regarded as the adjacent side of the magnetic component 4a. In the embodiment, the plastic frame 2d includes a plurality of windows 22, 24 surrounding the outer peripheral wall, such as the pair of first sidewalls 21 and the pair of second sidewalls 23 of the plastic frame 2a. In addition, the insulation tape 3b is looped around and attached to the outer peripheral wall of the plastic frame 2d, such as the pair of first sidewalls 21 and the pair of second side walls 23, so as to cover the windows 22, 24, and shield the adjacent sides of the magnetic component 4a corresponding to the plastic frame 2d. Through the windows 22, 24 and the insulation tape 3b corresponding to the adjacent sides of the magnetic component 4a, the thermal contact is formed, and it helps to further enhance the thermal transfer channel and meet the insulation requirements of the magnetic component 4a at the same time.

In the embodiment, the bottom opening 28 of the plastic frame 2d is regarded as the at least one through opening. In addition to facilitating the introduction of the heat dissipation adhesive 5 into the accommodation space 20 during potting, the arrangement of the bottom opening 28 is further helpful for increasing the heat dissipation capability of the magnetic component 4 at the first side 41a. In the embodiment, the magnetic component assembly 1d further includes an auxiliary insulation tape 7b, which is attached to the first side 41a of the magnetic component 4a. In this way, the magnetic component 4a is shielded in the direction of the at least one through opening (i.e., the bottom opening 28) facing the magnetic component 4a, so as to meet the insulation requirements of the magnetic component 4a relative to the metal housing 6 in the direction of the Z axis. Certainly, the present disclosure is not limited thereto.

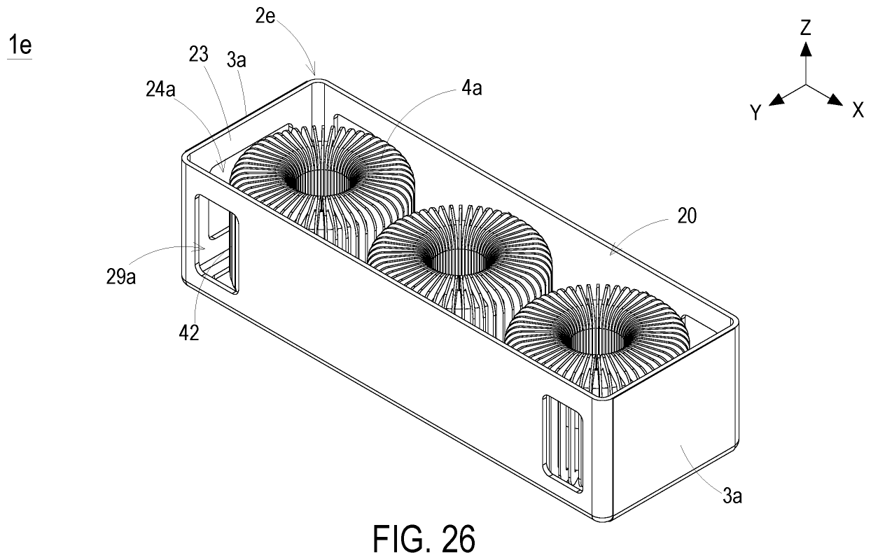

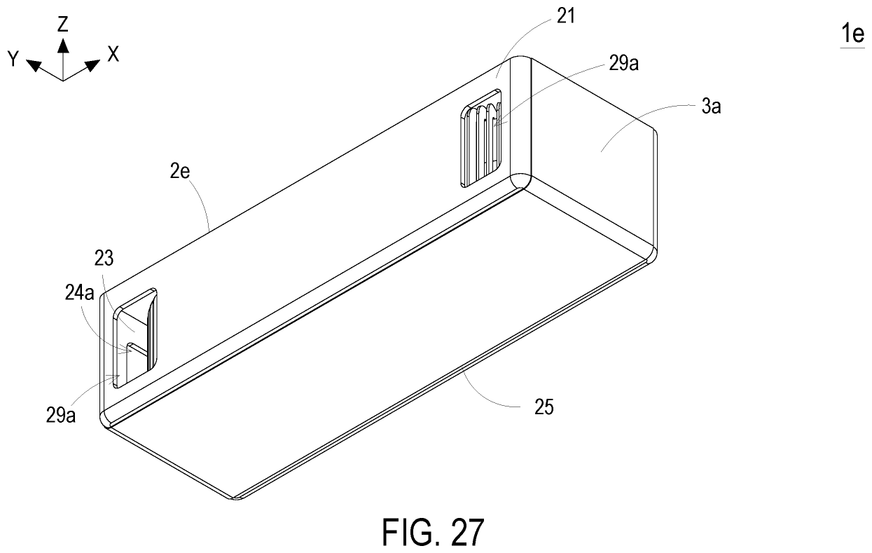

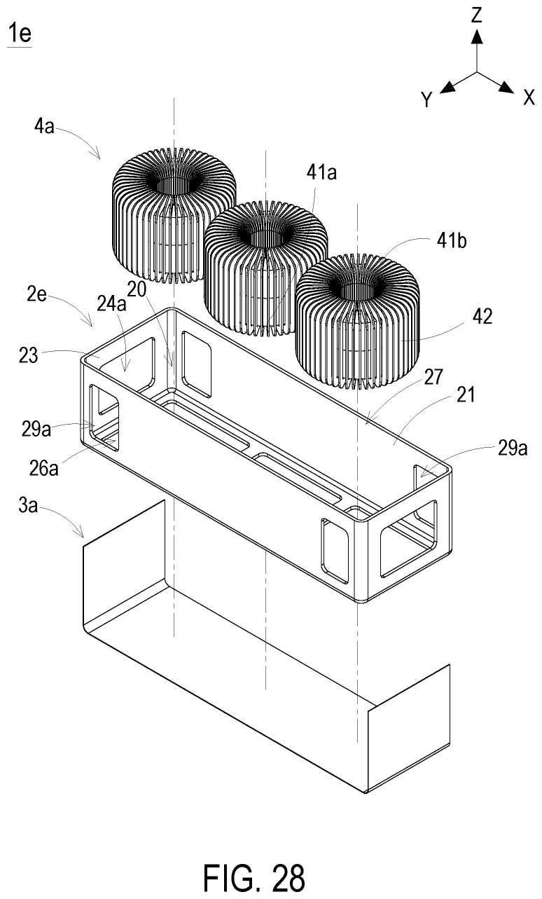

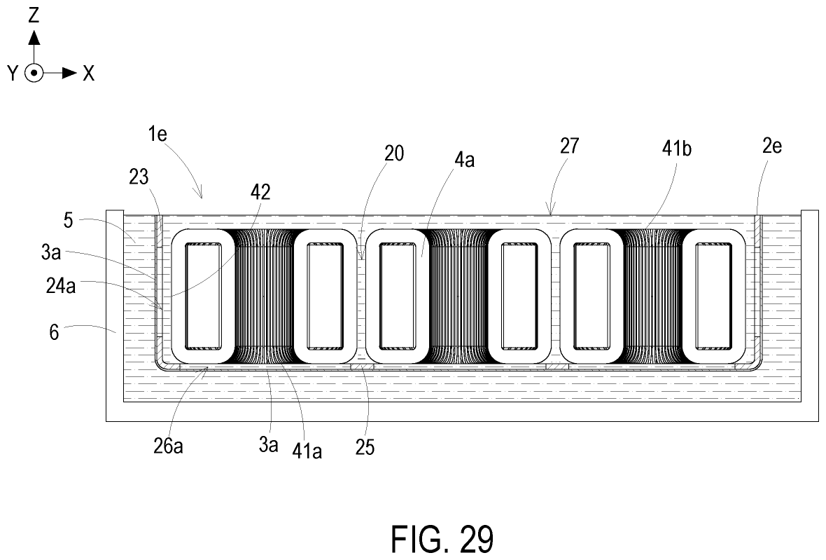

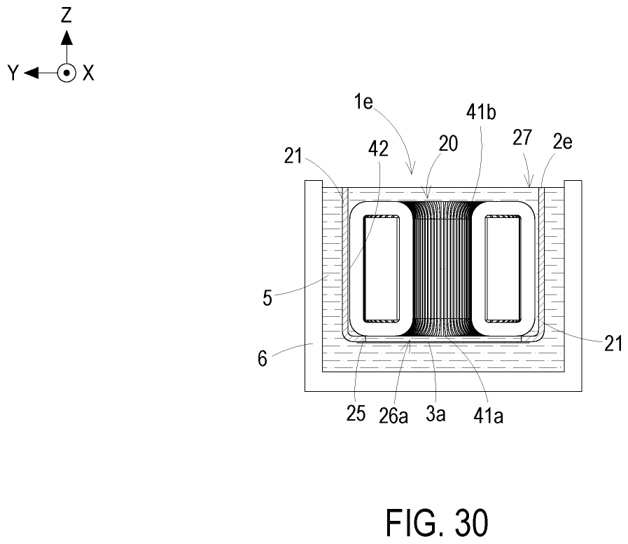

FIG. 26 is a perspective structural view illustrating a magnetic component assembly according to a sixth embodiment of the present disclosure and taken from a top perspective. FIG. 27 is a perspective structural view illustrating the magnetic component assembly according to the sixth embodiment of the present disclosure and taken from a bottom perspective. FIG. 28 is an exploded view illustrating the magnetic component assembly according to the sixth embodiment of the present disclosure. FIG. 29 is s a longitudinal cross-sectional view the magnetic component assembly potted in the metal housing according to the sixth embodiment of the present disclosure. FIG. 30 is a transverse cross-sectional view illustrating the magnetic component assembly potted in the metal housing according to the sixth embodiment of the present disclosure. In the embodiment, the structures, elements and functions of the magnetic component assembly 1e are similar to those of the magnetic component assembly 1c of FIGS. 16 to 20, and are not redundantly described herein. In the embodiment, the magnetic component assembly 1e includes a magnetic component 4a, a plastic frame 2e and an insulation tape 3a. The outer ring surface 42 of the magnetic component 4a is disposed adjacent to the outer peripheral wall of the plastic frame 2e, such as the first sidewalls 21 and the second sidewalls 23. In addition, the through opening 29a of the plastic frame 2e is further disposed at one end of the first sidewall 21, and arranged adjacent to the connection between the first sidewall 21 and the second sidewall 23. In other implementations, the through opening 29a of the plastic frame 2e is disposed at one end of the second sidewall 23 and arranged adjacent to the connection between the first sidewall 21 and the second sidewall 23. In the embodiment, the outer ring surface 42 of the magnetic component 4a is disposed adjacent to the outer peripheral wall of the plastic frame 2e such as the first sidewalls 21 and the second sidewalls 23. Moreover, a sufficient creepage distance from the through opening 29a on the first sidewall 21 to the outer ring surface of the magnetic component 4a is maintained. Since the magnetic component assembly 1e is applied in the metal housing 6 and potted with the heat dissipation adhesive 5, the requirements for low thermal resistance and high insulation level on the adjacent side of the magnetic component 4a are particularly stringent. Through the windows 22, 24 and the insulation tape 3 corresponding to the adjacent side of the magnetic component 4a, the thermal contact is formed on, and it helps to further enhance the thermal transfer channel and meet the insulation requirements of the magnetic component 4a at the same time. In addition, the heat dissipation adhesive 5 is introduced through the through opening 29a for potting, a sufficient creepage distance from the outer ring surface 42 of the magnetic component 4a to the through opening 29a is maintained, and the area of the plastic frame 2e without windows and through openings also plays an auxiliary role in heat dissipation. Certainly, the present disclosure is not limited thereto.

From the above, the plastic frames 2, 2a, 2b, 2c, 2d, 2e include the windows corresponding to the adjacent sides of the magnetic components 4, 4a to form the directional and efficient thermal transfer channels, and the windows are covered by insulation tape to shield the magnetic components 4, 4a. In that, it allows to enhance the heat dissipation capability and meet the requirements of high insulation level requirements at the same time. On the other hand, the plastic frame 2, 2a, 2b, 2c, 2d, 2e include the through openings 26, 29, 29a or bottom openings 28 misaligned with adjacent sides of the magnetic components 4, 4a. It is helpful to introduce the heat dissipation adhesive 5 from the metal housing 6 to the accommodation space 20 and directly thermally couple with the magnetic components 4, 4a. Furthermore, with the arrangement of the auxiliary insulation tape, the potting procedure and the assembling procedure are simplified, the overall heat transfer efficiency is improved, and the creepage distance of the magnetic components 4, 4a relative to the metal housing 6 is increased. It meets the heat dissipation and insulation requirements of the magnetic component 4 and 4a in the application environment at the same time. In other embodiments, the positions of the windows and the openings on the plastic frames 2, 2a, 2b, 2c, 2d, 2e are adjustable according to the shape of the magnetic components 4, 4a or the position of the adjacent sides. The present disclosure is not limited thereto, and not redundantly described herein.

In summary, the present disclosure provides a magnetic component assembly. For solving the insulation and heat dissipation problems of the magnetic component, especially an inductor or a transformer, a plastic frame with a window and an insulation tape are combined to form an assembly structure that not only meets the safety insulation requirements, but also can dissipate heat efficiently. Moreover, corresponding to the position of an adjacent side of the magnetic component, a directional thermal transfer channel is formed to enhance the thermal transfer capacity in this direction sufficiently, and meet the insulation requirements of the magnetic component in the application environment. With the combination of the magnetic components, the window and the insulation tape, an optimized thermal transfer channel is formed to enhance the heat dissipation efficiency of the magnetic component, simplify the assembling and manufacturing process and reduce the cost at the same time. The window and the through opening disposed on the plastic frame are utilized to attach an insulation tape and introduce the potting compound, respectively, so as to solve the insulation problem and the heat dissipation problem of the magnetic component at the same time. Since the magnetic component assembly is applied in a metal housing and potted with the heat dissipation adhesive, the requirements for low thermal resistance and high insulation level on the adjacent side of the magnetic component are particularly stringent. When the magnetic component is accommodated in the plastic frame, an insulation protection is provided. Moreover, the windows and the insulation tape are arranged and corresponding to the adjacent side of the magnetic component, so as to form a thermal contact, it allows to further optimize the thermal transfer channel and meet the insulation requirements of the magnetic component at the same time. In this way, the magnetic component is close to the metal housing and less than the safety creepage distance, and it also meets the insulation requirements. In addition, the insulation tape is attached to the plastic frame to cover the window, and the magnetic component is directly placed in the plastic frame to realize the thermal contact between the adjacent side of the magnetic component and the corresponding window with the insulation type. The structure is compact and easy to assemble. It avoids the conventional technology, which winds the insulation tape on the whole of the magnetic component through the complicated procedures. Furthermore, the through openings of the plastic frame are misaligned with the adjacent side of the magnetic component, so that the heat dissipation adhesive is introduced into the accommodation space through the through openings and in contact with the magnetic component, and the thermal conductivity is improved. The portion of plastic frame without the windows and the through openings is utilized to separate the magnetic component from the metal housing, increase the creepage distance and meet the safety requirements. Furthermore, the arrangement of the portion of plastic frame without the windows and the through openings is helpful of heat dissipation. The insulation tape is pre-disposed on the plastic frame, and the heat dissipation adhesive is potted after the magnetic component is placed. It allows the magnetic component to form a thermal coupling with the metal housing through the plastic frame, the insulation tape and the potted heat dissipation adhesive. It has advantages of simplifying the assembling process, enhancing the thermal transfer efficiency and meeting the insulation requirements of the magnetic components in the application of the metal housing. In addition, the window is opened on the plastic frame and corresponding to the shortest thermal transfer path between the adjacent side of the magnetic component and the metal housing, so that the thermal resistance is reduced sufficiently, and the heat dissipation performance is enhanced. On the other hand, the insulation tape is attached to the plastic frame and corresponding to the window, so that the insulation protection is achieved, and the creepage distance from the adjacent side of the magnetic component to the metal housing is increased at the same time. The insulation performance of the magnetic component relative to the metal housing is ensured and not affected by the opening position of the windows of the plastic frame.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component assembly comprising:
a magnetic component comprising at least one adjacent side;
a plastic frame comprising an accommodation space, at least one window and at least one through opening, wherein the magnetic component is accommodated in the accommodation space, the at least one window is spatially corresponding to the at least one adjacent side of the magnetic component, and the at least one through opening is in communication with the accommodation space; and
an insulation tape attached to the plastic frame, covering the at least one window, and shielding the at least one adjacent side of the magnetic component.

2. The magnetic component assembly according to claim 1, wherein the plastic frame comprises a top opening and an outer peripheral wall, the outer peripheral wall forms the accommodation space, the top opening is in communication with the accommodation space, and the magnetic component is accommodated in the accommodation space through the top opening.

3. The magnetic component assembly according to claim 2, wherein the at least one window is disposed on the outer peripheral wall.

4. The magnetic component assembly according to claim 3, wherein the magnetic component is in a shape of a cylinder comprising a first side and a second side opposite to each other and an outer ring surface, and the first side and the second side are connected through the outer ring surface, wherein the magnetic component is vertically accommodated in the accommodation space through the top opening, the at least one window is spatially corresponding to the first side or/and the second side or/and a part of the outer ring surface, and the at least one adjacent side is defined as the first side or/and the second side or/and the part of the outer ring surface that is shielded due to the insulation tape covering the at least one window.

5. The magnetic component assembly according to claim 4, wherein the plastic frame further comprises a bottom plate, the at least one through opening is arranged on the bottom plate, the outer ring surface has a bottom, the bottom of the outer ring surface is arranged adjacent to the bottom plate, and the at least one through opening is disposed and misaligned with the bottom of the outer ring surface.

6. The magnetic component assembly according to claim 4, wherein the plastic frame further comprises a bottom opening, and the top opening and the bottom opening are disposed opposite to each other and in communication with the accommodation space, wherein the bottom opening is defined as the at least one through opening.

7. The magnetic component assembly according to claim 6, wherein magnetic component assembly further comprises an auxiliary insulation tape attached to the magnetic component to shield the magnetic component in a viewing direction of the at least one through opening facing the magnetic component.

8. The magnetic component assembly according to claim 3, wherein the magnetic component is in a shape of a cylinder comprising a first side and a second side opposite to each other and an outer ring surface, and the first side and the second side are connected through the outer ring surface, wherein the magnetic component is horizontally accommodated in the accommodation space through the top opening, the at least one window is spatially corresponding to the outer ring surface of the magnetic component, and the at least one adjacent side is defined as the outer ring surface that is shielded due to the insulation tape covering the at least one window.

9. The magnetic component assembly according to claim 8, wherein the plastic frame further comprises a bottom opening, and the top opening and the bottom opening are disposed opposite to each other and in communication with the accommodation space, wherein the bottom opening is defined as the at least one through opening.

10. The magnetic component assembly according to claim 9, wherein magnetic component assembly further comprises an auxiliary insulation tape attached to the magnetic component to shield the magnetic component in a viewing direction of the at least one through opening facing the magnetic component.

11. The magnetic component assembly according to claim 3, wherein the at least one window includes a plurality of windows disposed around the outer peripheral wall of the plastic frame, and the insulation tape is arranged around the outer peripheral wall of the plastic frame.

12. The magnetic component assembly according to claim 2, wherein the plastic frame further comprises a bottom plate, the at least one window is arranged on the bottom plate.

13. The magnetic component assembly according to claim 12, wherein the magnetic component is in a shape of a cylinder comprising a first side and a second side opposite to each other and an outer ring surface, and the first side and the second side are connected through the outer ring surface, wherein the magnetic component is horizontally accommodated in the accommodation space through the top opening, the at least one window is spatially corresponding to the first side of the magnetic component, and the at least one adjacent side includes the first side that is shielded due to the insulation tape covering the at least one window.

14. The magnetic component assembly according to claim 13, wherein the at least one through opening is disposed on the outer peripheral wall, the outer ring surface has a bottom, the bottom of the outer ring surface is disposed adjacent to the outer peripheral wall, and the at least one through opening is disposed and corresponding to the bottom of the outer ring surface.

15. The magnetic component assembly according to claim 14, wherein the plastic frame further comprises at least one opening arranged on the outer peripheral wall at a position where the at least one opening is not disposed thereon, and the insulation tape is attached on the outer peripheral wall to cover the at least one opening.

16. The magnetic component assembly according to claim 14, further comprising an auxiliary insulation tape disposed around the outer ring surface of the magnetic component.

17. The magnetic component assembly according to claim 13, wherein the at least one through opening is disposed on the outer peripheral wall, the outer ring surface has a bottom, the bottom of the outer ring surface is disposed adjacent to the outer peripheral wall, and the at least one through opening is disposed and misaligned with the bottom of the outer ring surface.

18. The magnetic component assembly according to claim 17, wherein the plastic frame further comprises at least one opening arranged on the outer peripheral wall at a position where the at least one opening is not disposed thereon, and the insulation tape is attached on the outer peripheral wall to cover the at least one opening.

19. The magnetic component assembly according to claim 17, wherein the outer peripheral wall includes a pair of first sidewalls and a pair of second sidewalls connected end to end, and the at least one through opening includes one through opening disposed adjacent to a junction of the first sidewall and the second sidewall.

20. The magnetic component assembly according to claim 1, wherein the magnetic component assembly is accommodated in a metal housing and potted in a heat dissipation adhesive, wherein the heat dissipation adhesive is introduced into the accommodation space through the at least one through opening and encapsulated the magnetic component to form a potted body.

21. The magnetic component assembly according to claim 1, wherein the plastic frame is a rectangular frame or a cube frame and includes a pair of first sidewalls and a pair of second sidewalls, and the pair of first sidewalls and the pair of second sidewalls are connected end to end to form the accommodation space.

22. The magnetic component assembly according to claim 1, wherein the magnetic component is an inductor or a transformer.
